(19) United States
(12) Patent Application Publication
(10) Pub. No.: US 2025/0174750 A1
(43) Pub. Date: May 29, 2025

(54) METHOD TO REDUCE THE RISK OF EXPLOSION OF A BATTERY FOR A MOBILE ROBOT

(71) Applicants: ANYBOTICS AG, Zürich (CH); PETROLIAM NASIONAL BERHAD (PETRONAS), Kuala Lumpur (MY)

(72) Inventors: Mehmet Mutlu, Dietlikon (CH); Taihei Ueno, Zürich (CH); Enea Scioni, Luzem (CH); Iskandar AI-Thani Mahmood, Kajang (MY)

(21) Appl. No.: 18/844,144

(22) PCT Filed: Mar. 9, 2022
(86) PCT No.: PCT/EP2022/056079

§ 371 Date: Sep. 5, 2024

(51) Int. Cl. H01M 10/635; H01M 10/48

(52) U.S. Cl. CPC H01M 10/635; H01M 10/486; H01M 2200/20; H01M 2220/20

(57) ABSTRACT

The invention refers to a method to reduce the risk of explosion of a battery (1) of a mobile robot. The mobile robot (2) comprises a battery housing (10), a first sensor adapted to measure a first environmental parameter of the battery housing (10), and a safety unit adapted to receive first sensor data of the first environmental parameter measured by the first sensor. The method comprises the steps of monitoring the first sensor data measured by the first sensor by means of the safety unit and starting to run a safety measure by the safety unit, wherein the safety measure comprises a step of returning, by the robot (2), to a safety zone if the first sensor data deviates from a predetermined data range of the first sensor data.

### TECHNICAL FIELD

The invention refers to a method to reduce the risk of explosion of a battery of a mobile robot, a computer program product for controlling the mobile robot, a battery adapted to run the method, a mobile robot comprising the battery and a use of the battery.

### BACKGROUND ART

Mobile, in particular legged, robots are used for various tasks, in particular for supporting human work in hazardous environments.

To use a mobile robot in an explosive environment, in particular explosive gas or dust, it is advantageous if the robot is constructed to fulfil some precaution measures. For example, the robot should be constructed in a way that it does not ignite explosions in such an environment.

One challenge in this regard is to construct the robot in such a way that the battery does not explode if e.g. explosive gas enters the robot torso.

Wang, W et al. “Robot Protection in the Hazardous Environments”, Robot Protection in the Hazardous Environments, Chapter 4, INTECH Open Science, 2017, discloses prior art regarding an explosion-proof housing for a battery. According to Wang et al. an explosion-proof housing of a battery cannot be completely sealed due to driving shaft. Therefore, filling the battery housing with an inert gas is not a feasible solution to provide an explosion-proof housing. As mentioned in Wang et al., robots as known in prior art, are employing a gum-filling explosion-proof method in the battery housing. As the gum occupies the space in the battery housing, the volume of explosive gas is sharply reduced and thus explosions are prevented.

Anyway, such methods of using a gum-filled housing leads to very heavy batteries, which might be disadvantageous for a robot, in particular for a legged robot.

### DISCLOSURE OF THE INVENTION

The problem to be solved by the present invention is therefore to provide a method to prevent ignition of a battery of a robot in an explosive environment and that overcomes the disadvantages of the prior art solutions.

This problem is solved by a first aspect of the invention referring to a method to reduce the risk of explosion of a battery of a mobile robot, a second aspect of the invention referring to a computer program product for controlling a mobile robot, a battery adapted to run the steps of the method according to the first aspect and a use of the battery for a mobile robot in an explosive environment.

A first aspect of the invention refers to a method to reduce the risk of explosion of a battery of a mobile robot, in particular a legged robot, wherein the robot comprises a battery with a battery housing, a first sensor and a safety unit. The first sensor is adapted to measure a first environmental parameter of the battery housing. Since the battery housing is in fluid connection with a cavity of the robot torso, the first sensor might be arranged within the battery housing itself or might be arranged anywhere within the cavity.

Advantageously, the torso is the main body of the robot, where most of the computing power and electronic components are located.

Advantageously, the cavity is the inner space within a robot torso, wherein different components of the robot are located. In particular, the cavity is the room within the robot torso that has the same absolute pressure. That means, all the space within the robot that is in fluid connection is part of the cavity. The cavity is gas sealed from the environment. Therefore, absolute pressure is the same within the cavity and within the battery housing. Therefore, advantageously, the term “environmental parameter of the battery housing” refers to a parameter for the condition of the battery housing, wherein the parameter can be measured anywhere in the cavity.

In particular, the term “environmental parameter” refers to an environment in the battery housing or can refer to an environment in the cavity respectively, since the battery housing is in fluid connection with the cavity, e. g. for the pressure parameter.

The safety unit is adapted to receive first sensor data of the first environmental parameter measured by the first sensor.

The method comprises the steps of:
monitoring the first sensor data measured by the first sensor by means of the safety unit, and.
starting to run a safety measure by the safety unit, wherein the safety measure comprises a step of returning, by the robot, to a safety zone if the first sensor data deviates from a predetermined data range of the first sensor data.

Advantageously, the safety zone is a predefined area where the risk of explosion does not exist, e.g. an area outside of the explosive gas environment.

Further advantageously, the safety zone is an area where the risk of explosion does not exist, defined by a user and dynamically adapted during a mission of the mobile robot.

Advantageously, the safety unit is starting to run the safety measure if p_{d}≤500 Pa, in particular if p_{d}≤50 Pa.

In an advantageous embodiment of the invention, the battery housing is connected to a cavity, respectively in fluid connection with the cavity, of a robot torso. In particular, the torso is the main body of the robot, where most of the computing power and electronic components are located.

Advantageously, the battery housing is arranged partially inside the robot torso and partially outside, wherein the inner space of the battery housing is in fluid connection with the cavity and is sealed towards the environment.

In a further advantageous embodiment of the method, the battery comprises a second sensor adapted to measure a second environmental parameter of the battery housing. In addition, the safety unit is further adapted to receive second sensor data of a second environmental parameter measured by the second sensor. The method comprises the steps of additionally monitoring the second sensor data measured by the second sensor by the safety unit. In addition, the method comprises the step of starting to run at least one further safety measure the safety unit, if the second sensor data deviates from a predetermined data range of the second sensor data.

Advantageously, a further safety measure might be:
a shutdown of the battery, in particular if p_{d}≤50 Pa and/or
a shutdown of the robot, in particular if p_{d}≤50 Pa, and/or
a return of the robot to a docking station that is placed within the safety zone, in particular if p_{d}≤500 Pa.

Advantageously, the term “docking station” refers to a charging station for the robot, where the robot can in particular recharge the battery.

In a further advantageous embodiment of the inventive method, the battery comprises one or further sensors adapted to measure one more further or environmental parameter of the battery housing. The safety unit is additionally adapted to receive one or more further sensor of one or more further data environmental parameter measured by the respective one or more further sensors. The method comprises the steps of monitoring additionally the respective one or more further sensor data measured by the respective one or more further sensors by the safety unit. In addition, the method comprises the step of starting to run at least one further safety measure by the safety if the respective one or further sensor data deviates from a predetermined data range of the respective one or more further sensor data.

A further advantageous embodiment of the method comprises the step of starting to run the further safety measure if the first and the second and/or the one or more further sensor data deviate from a predetermined data range of the first and the second and/or the one or more further sensor data.

In a further advantageous embodiment of the inventive method, the first, the second, and/or the one or more further sensor is adapted to measure a differential pressure pa providing the first, the second, and/or the respective one or more further sensor data.

To measure the differential pressure pa, an absolute pressure p_{b} inside the battery housing and an ambient pressure pₐ outside the cavity or robot torso respectively is measured, wherein p_{d}=p_{b}−pₐ.

Advantageously, the safety unit is starting to run at the safety measure and/or the at least one further safety measure if p_{d}≤500 Pa, in particular if p_{d}≤50 Pa.

Advantageously, a differential pressure sensor therefore is built to comprise one sensor unit that is adapted to measure p_{b} and pₐ (e.g. a membrane of the sensor is exposed on one side to the battery housing and on the outer side to the environment of the cavity or torso respectively).

Further advantageously, the differential pressure sensor might also comprise two sensor units, wherein the first sensor unit is arranged within the cavity or battery housing to measure p_{b} and the second sensor unit is arranged outside of the cavity respectively torso of the robot to measure pₐ.

In a further advantageous embodiment of the invention, the first sensor is an absolute pressure sensor to measure the absolute pressure p_{b} of the battery housing. The second sensor is a temperature sensor to measure a temperature T_{B} of the battery housing. The robot or the battery comprises an environmental sensor for measuring the ambient pressure pₐ outside of the robot and the battery housing.

In a further advantageous embodiment of the robot, the battery a in comprises first sensor, particular an environmental sensor arranged within the housing of the battery or the cavity. In particular, the first sensor is adapted to measure the absolute pressure p_{b} of the battery housing. Further advantageously, the battery comprises a second sensor, adapted to measure an ambient pressure pₐ outside of the battery housing and outside of the robot. The second sensor might be considered as being an individual sensor. The differential pressure pa is defined as p_{d}=p_{b}−pₐ.

In a further advantageous embodiment of the invention the first sensor is adapted to measure the differential pressure p_{d} between an environmental pressure p_{b} of the battery housing and an ambient pressure pₐ outside the robot and the battery housing. For this embodiment, the first sensor comprises a sensor component arranged within the battery housing or within the cavity for measuring the environmental pressure p_{b} of the housing, and further comprises a sensor component adapted to measure an ambient pressure pₐ outside the housing and the robot.

In a further advantageous embodiment of the method, the first, the second, and/or the one or more further sensor is a temperature sensor adapted to measure a temperature of the battery housing and providing the first, the second, and/or the respective one or more further sensor data T_{B}, wherein the safety unit is starting to run the safety measure and/or the at least one further safety measure if T_{B}≥80° C.

Other advantageous embodiments are listed in the dependent claims as well as in the description below.

A second aspect of the invention refers to a computer program product for controlling a mobile robot. The computer program product comprises a computer readable storage having medium program instructions embodied therewith. The program instructions are executable by a control unit of the robot and cause the robot to perform the steps of the method according to the first aspect.

A third aspect of the invention refers to a battery adapted to run the steps of the method according to the first aspect.

In a further advantageous embodiment of the battery, the battery housing is in fluid connection with the cavity of the robot torso.

In another further advantageous embodiment of the invention, the battery comprises a port for connecting it to one or more electronic components of the robot.

In an advantageous embodiment of the invention, the battery comprises lithium-ion energy cells.

A fourth aspect of the invention refers to a mobile robot comprising the battery according to the third aspect.

Advantageously, the mobile robot is a quadruped autonomous robot.

A fifth aspect of the invention refers to a use of the battery according to the third aspect for a mobile robot in an explosive environment, in particular in a gaseous or dusty environment.

### BRIEF DESCRIPTION OF THE DRAWINGS

The invention will be better understood and objects other than those set forth above will become apparent from the following detailed description thereof. Such description makes reference to the annexed drawings, wherein:

FIG. 1 shows a schematic of an embodiment of a battery adapted to run the method according to the invention; and

FIG. 2 shows a schematic of an embodiment of a battery adapted to run the method according to the invention.

### MODES FOR CARRYING OUT THE INVENTION

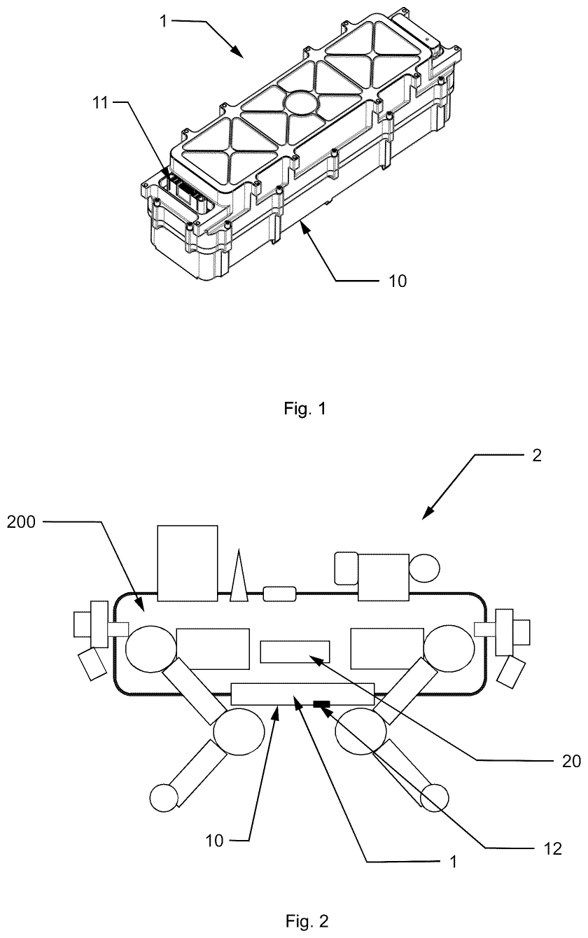

FIG. 1 shows a schematic of an embodiment of a battery 1 with a battery housing 10 according to the third aspect of the invention. The battery 1 comprises a battery housing 10 and a first sensor 12 adapted to measure a first environmental parameter within the battery housing. Furthermore, the battery 1 comprises a safety unit adapted to receive first sensor data of the first environmental parameter measured by the first sensor 12. In addition, arranged within the battery housing is one or more electrochemical cells for powering the robot.

An advantageous embodiment of the battery 1 the battery housing 10 is in fluid connection with the cavity 200 of the robot torso.

In a further advantageous embodiment of the battery 1, the battery 1 comprises a port 11 for connecting the battery 1 to one or more electronic components 20 of the robot 2.

In particular, the battery is adapted to run a method to reduce the risk of explosion of the battery 1 of a mobile robot 2.

In particular, the battery 1 is adapted to be used for a mobile robot 2 in an explosive environment.

The method comprises the steps of monitoring the first sensor data measured by the first sensor 12 by means of the safety unit and starting to run a safety measure by the safety unit. The safety measure comprises a step of returning, by the robot 2, to a safety zone if the first sensor data deviates from a predetermined data range of the first sensor data.

In a further advantageous embodiment of the method to reduce the risk of a battery explosion, the battery 1 comprises a second sensor adapted to measure a second environmental parameter within the battery housing 10. The safety unit is additionally adapted to receive second sensor data of a second environmental parameter measured by the second sensor. For this embodiment of the method, in addition to the first sensor data, also the second sensor data is monitored by the second sensor by means of the safety unit. At least one further safety measure is starting to run by means of the safety unit, if the second sensor data deviates from a predetermined data range of the second sensor data.

In a further advantageous embodiment of the inventive method, the battery 1 comprises one or more further sensors adapted to measure one or more further environmental parameters within the battery housing 10.

In particular, the term “environmental parameter” refers to an environment in the battery housing.

The safety unit is additionally adapted to receive one or more further sensor data of one or more further environmental parameter measured by the respective one or more further sensors. In addition to the first and/or second sensor data, the respective one or more further sensor data is measured by the respective one or more further sensors by means of the safety unit. The safety unit starts to run at least one further safety measure, if the respective one or more further sensor data deviates from a predetermined data range of the respective one or more further sensor data.

In an advantageous embodiment of the invention, the further safety method is initiating a shutdown of the battery and/or a shutdown of the robot and/or a return to a docking station that is placed within the safety zone.

In a further advantageous embodiment of the invention, the further safety measure is initiated by the safety unit if the first and the second and/or the one or more further sensor data deviate from a predetermined data range of the first and the second and/or the one or more further sensor data.

In an advantageous embodiment of the invention, the further safety measures are a shutdown of the battery, a shutdown of the robot, and/or a return of the robot to a docking station that is placed within the safety zone.

In a further advantageous embodiment of the invention, the first, the second and/or the one or more further sensor is a pressure sensor adapted to measure an absolute pressure p_{b} within the battery housing 10.

In a further advantageous embodiment of the invention, the first, the second and/or the one or more further sensor is a temperature sensor adapted to measure a temperature T_{B} within the battery housing 10.

FIG. 2 shows a schematic of a robot 2 according to an embodiment of the invention. The robot comprises the battery 1 as shown in FIGS. 1a and 1b.

In the particular embodiment of the robot, the battery comprises a first sensor 12, in particular an environmental sensor arranged within the housing 10 of the battery 1. In particular, the first sensor 12 is adapted to measure the differential pressure p_{d} between the pressure p_{b} of the battery housing 10 and the ambient pressure pₐ. The differential pressure sensor might comprise only one sensor unit to measure the sensor data or might comprise two sensor units, wherein one sensor unit measures pₐ and the second sensor unit measures p_{b}. Further advantageously, the battery comprises a second sensor. The second sensor 13 might be considered as being sensor. an individual In a further advantageous embodiment of the invention the first sensor is adapted to measure the differential pressure p_{d} between an environmental pressure p_{b} within the battery housing and an ambient pressure pₐ outside the robot 2 and the battery housing 10. For this embodiment, the first sensor comprises the first sensor unit arranged within the battery housing 10 for measuring the pressure p_{b} within the housing, and further comprises the second sensor unit adapted to measure an ambient pressure pₐ outside the housing 10 and the robot 2.

In a further advantageous embodiment of the invention, the battery housing 10 can further comprise a second sensor that is a temperature sensor to measure an environmental temperature T_{B} within the housing.

An advantageous embodiment of the robot 2 as shown in FIG. 2 is a mobile robot 2.

Advantageously, the battery 1 is connected to one or more electronic components 20 of the robot 1.

### Reference Table

1 Battery
10 Battery housing
11 Port
12 First sensor/sensor component
2 Robot
20 One or more electronic components
200 Cavity of robot torso

1. Method to reduce the risk of explosion of a battery of a mobile robot, wherein the robot comprises
a battery with a battery housing,
a first sensor adapted to measure a first environmental parameter of the battery housing, and
a safety unit adapted to receive first sensor data of the first environmental parameter measured by the first sensor,
the method comprising the steps of:
monitoring the first sensor data measured by the first sensor by means of the safety unit,
starting to run a safety measure by the safety unit, wherein the safety measure comprises a step of returning, by the robot, to a safety zone if the first sensor data deviates from a predetermined data range of the first sensor data.

2. The method according to claim 1,.
wherein the robot comprises a second sensor adapted to measure a second environmental parameter of the battery housing,
wherein the safety unit is additionally adapted to receive second sensor data of a second environmental parameter measured by the second sensor,
the method comprising the steps of:
monitoring additionally the second sensor data measured by the second sensor by the safety unit,
starting to run at least one further safety measure by the safety unit, if the second sensor data deviates from a predetermined data range of the second sensor data.

3. The method according to claim 1,
wherein the robot comprises one or more further sensors adapted to measure one or more further environmental parameter of the battery housing,
wherein the safety unit is additionally adapted to receive one or more further sensor data of one or more further environmental parameter measured by the respective one or more further sensors,
the method comprising the steps of:
monitoring additionally the respective one or more further sensor data measured by the respective one or more further sensors by the safety unit,
starting to run at least one further safety measure by the safety unit, if the respective one or more further sensor data deviates from a predetermined data range of the respective one or more further sensor data.

4. The method according to claim 1, wherein the first, the second, and/or the one or more further sensor is adapted to measure a differential pressure p_{d}, between the absolute pressure p_{b} of the battery housing and an ambient pressure pₐ, and providing the first, second, and/or respective one or more further sensor data,
in particular, wherein the safety unit is starting to run the safety measure and/or the least one further safety measure if p_{d}≤500 Pa, in particular if p_{d}≤50 Pa.

5. The method according to claim 1, wherein the further safety measure is:
a shutdown of the battery, in particular if p_{d}≤50 Pa, and/or
a shutdown of the robot, in particular if p_{d}≤50 Pa, and/or
a return of the robot to a docking station that is placed within the safety zone, in particular if p_{d}≤500 Pa.

6. The method according to claim 2, comprising the steps of starting to run the further safety measure if the first and the second and/or the one or more further sensor data deviate from a predetermined data range of the first and the second and/or the one or more further sensor data.

7. The method according to claim 1, wherein the first, the second, and/or the one or more further sensor is a temperature sensor adapted to measure a temperature of the battery housing and providing the first, second, and/or respective one or more further sensor data T_{B},
in particular, wherein the safety unit is starting to run the safety measure and/or the at least one further safety measure if T_{B}≥80° C.

8. A computer program product for controlling a mobile robot, the computer program product comprising a computer readable storage medium having program instructions embodied therewith, the program instructions executable by a control unit of the robot to cause the robot to perform the steps of the method according to claim 1.

9. A battery adapted to run the steps of the method according to claim 1.

10. The battery according to claim 9, wherein the battery housing is in fluid connection with a cavity of a robot torso.

11. A mobile robot comprising the battery according to claim 9.

12. Use of the battery according to claim 9 for a mobile robot in an explosive, in particular in a gaseous and/or dusty environment.
